(19) United States
(12) Patent Application Publication
(10) Pub. No.: US 2026/0027770 A1
(43) Pub. Date: Jan. 29, 2026

(54) Tuning Crosslinking of Hybrid Preceramic Polymers in Vat Photopolymerization Toward Controlled Ceramic Yields

(71) Applicants: UNM RAINFOREST INNOVATIONS, Albuquerque, NM (US); UT-Battelle, LLC, Oak Ridge, TN (US)

(72) Inventors: Sungjin KIM, Albuquerque, NM (US); Tomonori SAITO, Oak Ridge, TN (US); Corson CRAMER, Fort Collins, CO (US)

(73) Assignees: UNM RAINFOREST INNOVATIONS, Albuquerque, NM (US); UT-Battelle, LLC, Oak Ridge, TN (US)

(21) Appl. No.: 19/278,918

(22) Filed: Jul. 24, 2025

Related U.S. Application Data
(60) Provisional application No. 63/675,061, filed on Jul. 24, 2024.

(51) Int. Cl. B29C 64/129; B29K 33/00; B29K 83/00; B29K 509/02; B33Y 10/00; B33Y 70/00

(52) U.S. Cl. CPC B29C 64/129; B33Y 10/00; B33Y 70/00; B29K 2033/08; B29K 2083/00; B29K 2509/02; B29K 2995/0082

(57) ABSTRACT

Control of preceramic polymer crosslinking for UV-curable processing is essential for fine 3D printing with high ceramic conversion for sustainable polymer-derived ceramics (PDC) engineering. While various factors influencing ceramic yield have been studied, the systematic exploration of the relationship between crosslinking and ceramic yield, especially when crosslinking increases volatile elements, remains open for further investigation. This addresses this gap by utilizing vat photopolymerization (VP) additive manufacturing (AM) as a versatile platform for controlling preceramic crosslinking and ceramic yield. By rationally designing and tuning the photochemical crosslinking through digital light processing (DLP), it is shown that the ceramic yield can be enhanced from 64% to over 86%, even with added volatile elements. The post-pyrolysis ceramic yield can be closely correlated with the pre-pyrolysis crosslinking of the preceramic network represented by its stiffness, which suggests a fast, energy-efficient, non-destructive methodology to predict and improve ceramic yield.

### REFERENCE TO RELATED APPLICATIONS

This application claims to the benefit of U.S. Provisional Patent Application No. 63/675,061, filed on Jul. 24, 2024, and is hereby incorporated by reference in its entirety.

### STATEMENT OF GOVERNMENT INTEREST

This invention was made with government support under grant no. DE-AC05-00OR22725 awarded by the Department of Energy. The government has certain rights in the invention.

### TECHNICAL FIELD

The present teachings relate generally to three-dimensional printing and, more particularly, to three-dimensional printing using photopolymerizable preceramic polymers.

### BACKGROUND

Engineering advances in ceramics derived from preceramic polymer processing provide promising potential in materials science, chemical engineering, and manufacturing science for their versatility and tunability. Preceramic polymers, typically consisting of silicon, carbon, and other elements, can be subjected to pyrolysis to yield polymer-derived ceramics (PDCs) with tailored properties suited for a wide range of applications, including aerospace, electronics, biomedicals, and energy storage.

Many preceramic polymers have the capability to undergo crosslinking prior to pyrolysis or other thermal processing. Understanding the role of crosslinking in the precursor polymer network is important for the successful organic-to-inorganic conversion of preceramic polymers into ceramic materials to provide high yield. Crosslinking, the formation of interconnecting bonds across separate polymer chains, augments the structural integrity and thermal stability of the polymeric material. Many preceramic polymers are designed to contain functional groups or reactive moieties that facilitate crosslinking through thermal, chemical, or photochemical processes. For example, such preceramic polymers based on polysiloxanes, polycarbosilanes, and polyborosilazanes often possess reactive groups including hydroxyl (—OH), and vinyl (—CH═CH₂) groups that can participate in crosslinking reactions. Preceramic polymers that undergo photochemical crosslinking can be applied in light-induced three-dimensional (3D) printing techniques such as stereolithography (SLA), and more specifically vat photopolymerization (VP). VP is an additive manufacturing (AM) technique that involves curing liquid photopolymer resins using light to form solid layers. The process typically takes place in a vat filled with photopolymer resin, where a light source selectively cures the resin layer-by-layer, building one or more additional layers, to build up the final 3D object. Sharing these principles, VP includes stereolithography (SLA), digital light processing (DLP), and two-photon polymerization (2PP), each differentiated based on their hardware and printing mechanisms and protocols. The preceramic polymer networks printed using these techniques are subjected to pyrolysis to transform to PDC in the desired 3D structure. During pyrolysis, mass loss occurs due to the decomposition and evaporation of volatile elements or organic components from the polymer matrix, leaving behind a residue rich in ceramic constituents such as silicon, carbon, and other inorganic elements. The weight fraction remaining after pyrolysis determines ceramic yield. The ceramic yield signifies the efficiency in converting polymer precursors into ceramic materials, impacting the manufacturing cost, energy efficiency, waste generation, and thus environmental sustainability.

Therefore, it is desirable to utilize such processes and materials to achieve high ceramic yields for improving resource utilization and economic viability, and lowering the carbon footprint of PDC fabrication and engineering. Such a goal aligns closely with the current global pursuit of a sustainable manufacturing and materials economy, particularly when combined with efforts to make such materials applicable to AM, a technology known for its outstanding energy and resource efficiency. Furthermore, while ongoing studies have been exploring numerous factors influencing ceramic yield, including precursor types, elemental composition, catalyst usage, heat treatment, and pyrolysis control, let alone various reaction routes feasible for photo-induced AM, a clear structure-property relationship between crosslinking and ceramic yield is yet to be established, and systematic studies are needed especially when volatile elements are incorporated more with crosslinking.

### SUMMARY

The following presents a simplified summary in order to provide a basic understanding of some aspects of one or more embodiments of the present teachings. This summary is not an extensive overview, nor is it intended to identify key or critical elements of the present teachings, nor to delineate the scope of the disclosure. Rather, its primary purpose is merely to present one or more concepts in simplified form as a prelude to the detailed description presented later.

A method for forming a three-dimensional part is disclosed. The method includes providing a container filled with a photopolymer resin, directing a light source towards the container filled with the photopolymer resin to cure a first layer of the three-dimensional part, and forming one or more additional layers of the three-dimensional part by directing the light source towards the container filled with the photopolymer resin, and removing the three-dimensional part from the container, and heating The three-dimensional part. The three-dimensional part has a ceramic yield of from about 60% to about 90%. The photopolymer resin may include a polycarbosilane, a methacrylate-based crosslinkable resin, or a diacrylate. The method for forming a three-dimensional part may include a crosslinker having a thiol-containing molecule represented by the formula SiOₐC_{b}X_{c}S_{d}Hₑ where x is selected from oxygen, boron, nitrogen, sulfur, hydrogen, titanium, platinum, and aluminum, and a is greater than or equal to 0, b is greater than or equal to 0, c is greater than or equal to 0, d is greater than 0, and e is greater than 0. The photopolymer resin may include a photoinitiator, and the method for forming a three-dimensional part may include where the light source operates in the ultraviolet range. Heating may include exposing the three-dimensional part to a temperature of from about 500° C. to about 1400° C., or exposing the three-dimensional part to an elevated temperature for a time of from about 0.5 hours to about 4 hours, or maintaining an atmosphere around the three-dimensional part, wherein the atmosphere comprises argon. Implementations of the described techniques may include hardware, a method or process, or computer software on a computer-accessible medium.

A three-dimensional part is disclosed, which can include a ceramic material comprising silicon and carbon, a polycarbosilane, and a polycarbosiloxane. The can include where the ceramic material has a ceramic yield of from about 60% to about 90%, or a stiffness of from about 0.2 MPa to about 0.5 MPa.

A composition is also disclosed, which can include a photopolymer resin, the photopolymer resin comprising a polycarbosilane, a polycarbosiloxane, and an acrylate-based crosslinkable resin. The composition, in implementations, can include a diacrylate, a crosslinker, or a photoinitiator. The composition may include a crosslinker having a thiol-containing molecule represented by the formula SiOₐC_{b}X_{c}S_{d}Hₑ where x is selected from oxygen, boron, nitrogen, sulfur, hydrogen, titanium, platinum, and aluminum, and a is greater than or equal to 0, b is greater than or equal to 0, c is greater than or equal to 0, d is greater than 0, and e is greater than 0.

The features, functions, and advantages that have been discussed can be achieved independently in various implementations or can be combined in yet other implementations further details of which can be seen with reference to the following description.

### BRIEF DESCRIPTION OF THE DRAWINGS

The accompanying drawings, which are incorporated in and constitute a part of this specification, illustrate embodiments of the present teachings and together with the description, serve to explain the principles of the disclosure. In the figures:

FIG. 1A is a schematic illustration depicting the scope of the VP crosslinking design, control, and evaluation on the pre-pyrolysis preceramic polymer network correlated with ceramic yield, offering rational design principles and sustainable processing strategies, in accordance with the present disclosure.

FIG. 1B depicts several exemplary chemical crosslinking reaction routes via DLP, using methacrylic resin (Genesis) or HDDA for acrylic addition polymerization and poly(mercaptopropyl)methylsiloxane (SMS-992) for thiol-ene click reaction to produce a crosslinked preceramic polymer network having a thiol-ene functionality, in accordance with the present disclosure.

FIG. 2A depicts images of SMP-10/Genesis samples printed in cuboid structures via DLP (PhotonS) with different crosslinking degrees controlled by UV exposure time, in accordance with the present disclosure.

FIG. 2B depicts plots exhibiting rheological frequency sweep profiles showing storage (G′) and loss moduli (G″) of the SMP-10/Genesis crosslinked with 1× (120 s), 2× (240 s), and 3× (360 s) UV exposure time (with a fixed 1× crosslinker amount; i.e., SMP-10:Genesis=1:1 by mass), in accordance with the present disclosure.

FIG. 2C shows plots depicting those crosslinked with 1× and 0.23× amounts of crosslinkers (with a fixed UV exposure time of 240 s), in accordance with the present disclosure.

FIG. 2D depicts an exemplary part, an oak leaf 3D structure from SMP-10/Genesis (1× crosslinker formulation) printed with a different printer, in accordance with the present disclosure.

FIG. 3A depicts an FTIR spectra of SMP 1-10, SMS-992, and SMP-10/SMS-992 crosslinked network formed via thiol-ene click reaction, in accordance with the present disclosure.

FIG. 3B depicts an FTIR spectra focused around 2550 cm-1, highlighted region in FIG. 3A, while the inset image shows the cuboids of the SMP-10/SMS-992 hybrid 3D-printed in a window pattern, in accordance with the present disclosure.

FIG. 4A is a plot showing compositions of ceramic yields after pyrolysis from the uncured SMP-10 (Uncrosslinked), SMP-10/SMS-992 hybrids crosslinked at UV intensity of 80%, 90% and that crosslinked with 2.5 times the photoinitiator amount at UV intensity of 90%, with TGA profiles of each sample with temperature ramped up to 900° C., in accordance with the present disclosure.

FIG. 4B is a plot showing a comparison of ceramic yields (weight %) of each sample, with a UV exposure time of 10 seconds for all compared cases, in accordance with the present disclosure.

FIGS. 5A and 5B are plots exhibiting the effects of UV intensity and UV exposure time on SMP-10/SMS-992 hybrid system on (FIG. 5A) G′max and (FIG. 5B) ceramic yield, in accordance with the present disclosure. FIG. 5C is a plot showing correlation between crosslink density represented by G′max and ceramic yield, with circles indicating the data from varying UV intensity (80-99%) at a fixed UV exposure time of 10 s (linear fitting R2=0.81), and squares indicating the data from varying UV exposure times (10-20 s) at a fixed intensity of 85% (linear fitting R2=0.95). The trendline indicates the linear fitting from the combined datasets disregarding DLP conditions (R2=0.78), in accordance with the present disclosure.

FIG. 6 is a plot of an X-ray Diffraction (XRD) measurement of an SMP-10/Genesis (1:1 weight ratio) crosslinked preceramic polymer, which can be pyrolyzed to produce amorphous SiC at 1000-1200° C. and crystallized to β-SiC at 1400° C. The crosslinking density of the preceramic polymer determined by the UV exposure time showed negligible effect on crystallinity after pyrolysis, in accordance with the present disclosure.

It should be noted that some details of the figures have been simplified and are drawn to facilitate understanding of the present teachings rather than to maintain strict structural accuracy, detail, and scale.

### DETAILED DESCRIPTION

Reference will now be made in detail to exemplary embodiments of the present teachings, examples of which are illustrated in the accompanying drawings. Wherever possible, the same reference numbers will be used throughout the drawings to refer to the same, similar, or like parts.

The present disclosure provides a system and method for accounting for the volatiles typically coming from species in the compositions used to assist in photocrosslinking for better ultraviolet-curable (UV-curable) shaping or forming, as well as to induce porous microstructures for desired applications, or in some examples, alternatively to induce increased density or controlled shrinkage within the formed microstructures. However, they are widely known to be disadvantageous to the ceramic yield as the tradeoff. Therefore, the simultaneous increases in the crosslinks and volatile elements would counteract each other in their effects on final ceramic yields, necessitating further investigation to unveil their combined effect.

It is provided herein that preceramic polymer crosslinking could present a major factor affecting the ceramic yield, thus the chemical design and VP processing to control crosslinking can be designed to deliver tuned properties from which the ceramic yield can be predicted before pyrolysis. In this context, a means of addressing this knowledge gap by conducting a systematic study focused explicitly on the role of crosslinking via DLP in preceramic polymer networks and its impact on ceramic yield is provided.

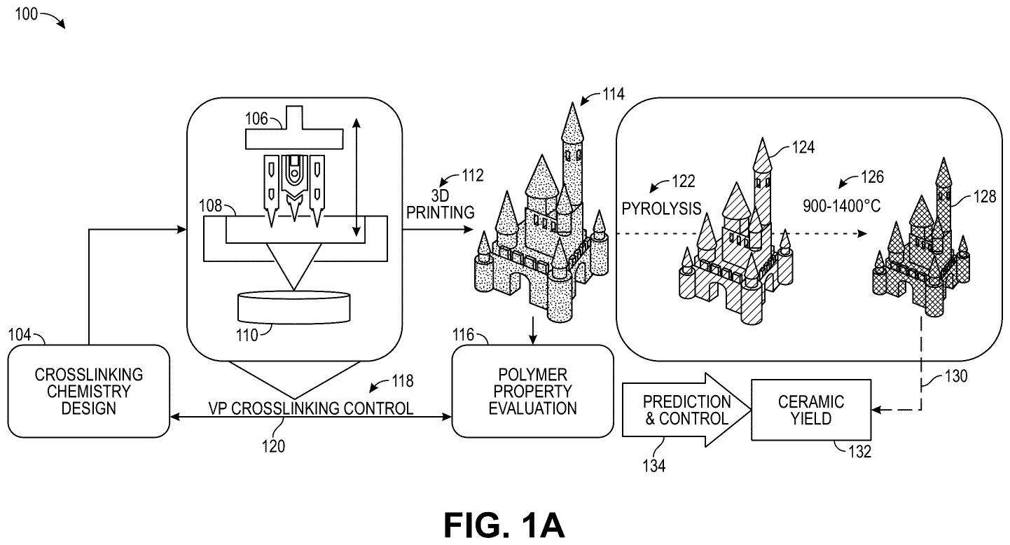

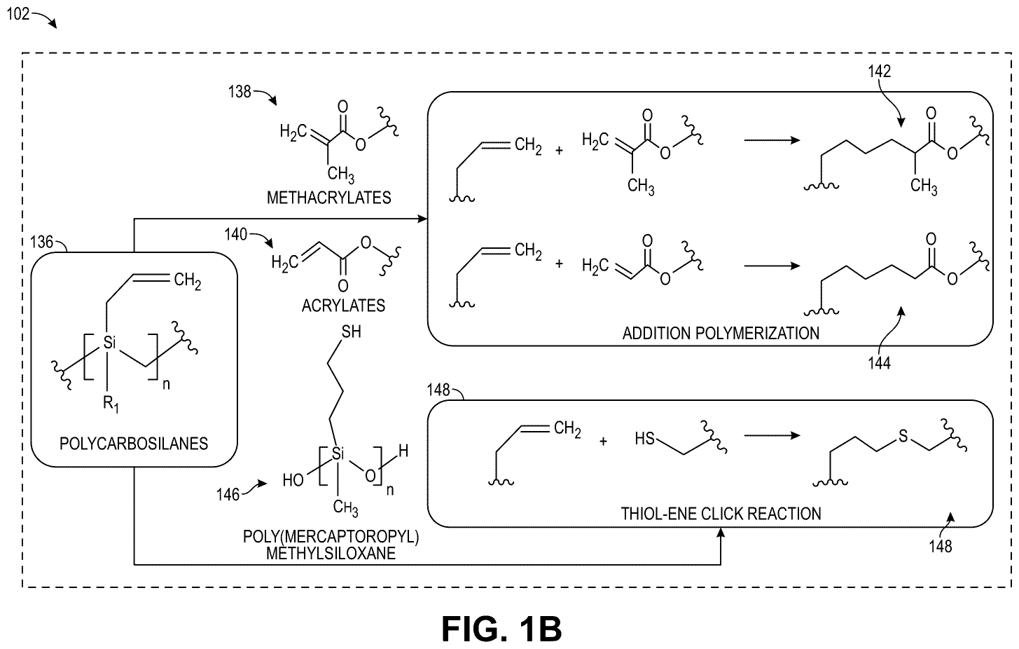

FIG. 1A is a schematic illustration depicting the scope of the VP crosslinking design, control, and evaluation on the pre-pyrolysis preceramic polymer network correlated with ceramic yield, offering rational design principles and sustainable processing strategies, in accordance with the present disclosure. FIG. 1B depicts several exemplary chemical crosslinking reaction routes via DLP, using methacrylic resin (Genesis) or HDDA for acrylic addition polymerization and a (mercaptopropyl)methylsiloxane homopolymer crosslinker such as poly(mercaptopropyl)methylsiloxane (SMS-992) for thiol-ene click reaction to produce a crosslinked preceramic polymer network, in accordance with the present disclosure.

Digital light processing (DLP) is a vat polymerization (VP) method that utilizes digital light projection through a screen with micropixel arrays to selectively crosslink liquid photopolymer in desired patterns layer-by-layer to 3D print. DLP offers tunability on diverse parameters with high-resolution features to regulate the photochemical crosslinking reaction such as light projection time and intensity that cannot be tuned by chemical formulation alone. Therefore, these systematic studies using a DLP process 100, and characterization of printed preceramic polymers offers insights for manipulating and forecasting ceramic yield from different design and processing cases, including the conundrum case where volatile elements are increased by crosslinking. These insights enable informed engineering decisions prior to the irreversible and energy-intensive pyrolysis process, achieved through crosslinking control and characterization of the preceramic polymer networks, as shown in FIG. 1A. The crosslinking chemistry design 104 of a system can feed into the DLP printing, which, in examples, can include a system having a build plate 106, reaction bath 108 and light source 110 to conduct a 3D printing 112 operation as normally associated with DLP printing, materials, and procedures. The reaction bath 108 can include the photopolymer resin, such as a polycarbosilane-polycarbosiloxane copolymer, crosslinkers, or other materials or examples as noted herein. A crosslinked preceramic polymer 114 can be subjected to polymer property evaluation 116 and characterization at this stage, where VP crosslinking control 118 can be fed into the formation of these properties and adjusted during print operations and part fabrication using iterative feedback 120 between the crosslinking chemistry design 104 and polymer property evaluation 116. Next, the crosslinked preceramic polymer 114 can be subjected to pyrolysis 122, where the part undergoing pyrolysis 124 can be exposed to increased or elevated temperature 126 of about 900° C. to about 1400° C., of from about 900° C. to about 1300° C., of from about 900° C. to about 1200° C., of from about 900° C. to about 1100° C., of from about 900° C. to about 1000° C., of from about 800° C. to about 900° C., of from about 500° C. to about 1400° C., of from about 500° C. to about 900° C., or of from about 700° C. to about 900° C. to obtain a polymer-derived ceramic 128. Finally, a conventional analysis 130 of the polymer-derived ceramic 128 can provide a quantification of ceramic yield 132 and be again subjected to polymer property evaluation 116, while this information and other learning from the other preceding steps can provide and exercise some prediction and control 134 over the results of the process.

FIG. 1B depicts several exemplary chemical crosslinking reaction routes via DLP, using methacrylic resin (Genesis) or HDDA for acrylic addition polymerization and poly(mercaptopropyl)methylsiloxane (SMS-992) for thiol-ene click reaction to produce a crosslinked preceramic polymer network, in accordance with the present disclosure. The ceramic or preceramic polymer can include silicon, carbon, silicon and carbon, or can include other elements, such as oxygen, boron, nitrogen, sulfur, hydrogen, titanium, platinum, and aluminum, or combinations thereof. Moreover, it is understood that this overall process 100 will lead to a better fundamental and practical understanding of the specific influence of photoactivated crosslinking on ceramic yield of the final part comprising a ceramic material, controlled via VP processing as well as the chemical formulation. In the overall process 102, polycarbosilane-based precursor material 136 (SMP-10, Starfire) is employed to design the photochemical crosslinking paths. For the reference crosslinking reaction, a methacrylate-based crosslinkable resin 138 (Genesis, Tethon3D) or diacrylates such as 1,6-hexanediol diacrylates 140 (HDDA) for inducing the acrylic 1 addition polymerization 142, 144 to couple with the alkene groups in SMP-10 were employed, as shown in FIG. 1B. In examples, other acrylates can include ethylene diacrylate, propane-1,3-diyl diacrylate, butane-1,4-diyl diacrylate, pentane-1,5-diyl diacrylate, 1,7-heptanediol diacrylate, 1,8-octanol diacrylate, 1,9-nonanediol diacrylate, 1,10-decanediol diacrylate, ethylene glycol diacrylate, di(ethylene glycol) diacrylate, tri(ethylene glycol) diacrylate, propylene glycol diacrylate, di(propylene glycol) diacrylate, tri(propylene glycol) diacrylate, or combinations thereof. Building onto this, the development of a polycarbosilane-polycarbosiloxane hybrid system that is crosslinked via a thiol-ene reaction can also be used. For this reaction, (mercaptopropyl)methylsiloxane homopolymer 146 (SMS-992, Gelest) containing many oxygen atoms was employed, to crosslink with alkene groups in the SMP-10 (FIG. 1B) via the thiol-ene click reaction 148 shown. Using these materials, chemical reactions, and DLP processing as the crosslinking platforms, the relation between the degree of crosslinking and ceramic yield was investigated. In examples, the crosslinker can include a thiol-containing molecule represented by the formula SiOₐC_{b}X_{c}S_{d}Hₑ, wherein X can include oxygen, boron, nitrogen, sulfur, hydrogen, titanium, platinum, and aluminum, or combinations thereof, a is greater than or equal to 0, b is greater than or equal to 0, c is greater than or equal to 0, d is greater than 0 and e is greater than 0. Examples can include poly(mercaptopropyl)methylsiloxane, trimethylolpropane tris(3-mercaptopropionate), dipentaerythritol hexakis(3-mercaptopropionate), pentaerythritol tetrakis(β-mercaptopropionate), octa(3-mercaptopropyl)silsesquioxane, thiolated poly(ethylene glycol) (peg-sh), thiolated chitosan/hyaluronic acid, polythiol-functionalized silica, or combinations thereof. Alternatively, instead of polycarbosilane-polycarbosiloxane copolymers, homopolymers can be used, such as, but not limited to polycarbosilane, polycarbosiloxane, polysilazane, and any combination of the copolymer of these.

### Methods and Materials

The materials used in the study of the present disclosure include Starfire Systems StarPCS SMP-10 polycarbosilane—silicon carbide matrix precursor (molecular weight MW 2,300-7,500 g/mol, Starfire Systems, Inc., New York, USA), Tethon3D Genesis methacrylate-base resin (MW proprietary, Tethon3D, Nebraska, USA), 1,6-hexanediol diacrylate (HDDA, Sigma-Aldrich), Gelest SMS-992 (mercaptopropyl)methylsiloxane homopolymer (MW 4,000-7,000 g/mol, Gelest, Inc., Pennsylvania, USA), phenylbis(2,4,6-trimethylbenzoyl)phosphine oxide (BAPO) photoinitiator (Sigma-Aldrich). All other materials including acetone or isopropanol for cleaning the vat after a printing cycle were purchased from Sigma-Aldrich unless specified otherwise.

### Reaction Mixture Preparation

SMP-10 was mixed with crosslinkers (e.g., Tethon3D Genesis, HDDA, Gelest SMS-992) and BAPO in desired concentrations. The reference formulation for the acrylic addition-based systems is the 1:1 weight ratio between the SMP-10 and the crosslinker (i.e., SMP-10/Genesis or SMP-10/HDDA). For the SMP-10/HDDA system, the photoinitiator BAPO was added as ˜2.4 wt. % in the reaction mixture to initiate the photoactivated reaction. The reference formulation for the thiol-ene reaction-based system (i.e., SMP-10/SMS-992) is the 32(±2):1 weight ratio between the SMP-10 and the crosslinker SMS-992. For this SMP-10/SMS-992 system, BAPO was included as ˜2 wt % in the reaction mixture. The reaction mixture was mixed vigorously at 2000 rpm for 2 minutes twice using a Thinky Mixer. The mixture was applied with additional physical shaking as needed to ensure sufficient mixing before transferring into the printing bath on the DLP printer. The procedure after the addition of the photoinitator was performed in a manner that minimizes exposure to the environmental lights before printing. In alternate examples, photoinitiators can include hydroxyacetophenones, diphenyl(2,4,6-trimethylbenzoyl)phosphine oxide, phenylbis(2,4,6-trimethylbenzoyl)phosphine oxide, ethyl (2,4,6-trimethylbenzoyl) phenylphosphinate, 2,2-mono-acylphosphine oxide, dimethoxy-2-phenylacetophenone, bis(4-methoxybenzoyl)diethylgermane, camphorquinone, 1-phenyl-1,2-propanedione, benzophenones, thioxanthones, or combinations thereof.

### Digital Light Processing (DLP)

The crosslinking reaction to produce solidified objects was processed through DLP using Anycubic PhotonS (China, max 0.43 mW/cm2, 405 nm) or Admatec Admaflex130 (Netherlands, max 115 mW/cm2, 405 nm). The acrylic crosslinking and 3D printing of three-dimensional parts were performed using PhotonS or Admaflex. The thiol-ene crosslinking and 3D printing were performed using Admaflex. The printing in PhotonS was processed with UV exposure time per layer selected in the range of 60-360 seconds and layer thickness setting of 25 m, where 120 s was selected as the reference condition (i.e., 1× exposure time). The printing in Admaflex was performed with a layer thickness setting of 20 m, UV exposure time per layer selected in the range of 10-20 seconds, and UV intensity adjusted by LED power in the range of 20-99% unless specified otherwise. A light source, known to one skilled in the art, operating in the ultraviolet range is suitable for the curing as described herein.

### Pyrolysis and Crystallization

Samples were pyrolyzed after DLP printing by placing the prints on graphite foil and running them in an atmosphere-controlled tube furnace up to 900° C. for 30 min at a heating rate of 3° C./min in N2. Samples that were crystallized were processed in an atmosphere-controlled furnace up to 1400° C. for 4 hours at a heating rate of 3° C./min in Argon.

### Rheological Characterization

The rheological frequency sweeps to obtain the shear storage modulus (G′) were performed using TA Instruments AR2000ex rheometer (Delaware, USA) using 4-mm aluminum parallel-plate geometry. The frequency sweep tests were performed at a 0.1- to 100 rad/s frequency range applying a constant strain at 1%. The data obtained from the frequency sweeps at 25, 35, 45, 55, and 65° C. were processed through time-temperature superposition to generate master curves at a reference temperature of 25° C. via TA Instrument TRIOS software by using the Williams-Landel-Ferry equation. G′max determined by the highest G′ observed in the tested angular frequency range was employed for comparing stiffness between different samples.

### Fourier Transform Infrared Spectroscopy (FTIR)

FTIR spectra were recorded with the Thermo Fisher Scientific Nicolet iS50 FTIR spectrometer (Massachusetts, USA) using the transmission mode on the specimens.

### Thermogravimetric Analysis (TGA)

The TGA was performed at the N₂ atmosphere with a flow rate of 60 mL/min using TA Instruments Q50 (Delaware, USA). The temperature was ramped up from room temperature to 900° C. with a ramp rate of 10° C./min. The ceramic yield (%) was determined by the remaining weight (%) after the measurement described by the following equation (eq 1):

$$Ceramic Yield ( \% ) = \frac{{m}_{1}}{{m}_{0}} \times 100 \% \qquad ( eq 1 )$$

where m₁ is the weight of the PDC after pyrolysis and m₀ is the weight of the original green material before pyrolysis.

### X-Ray Diffractometry (XRD)

Rapid X-ray powder diffraction analysis was performed using an Empyrean XRD instrument (Malvern Panalytical, UK) to measure the crystallinity of the specimen. The diffraction data were collected over 20 ranging from 5° to 90° using K alpha copper radiation.

### EXAMPLES

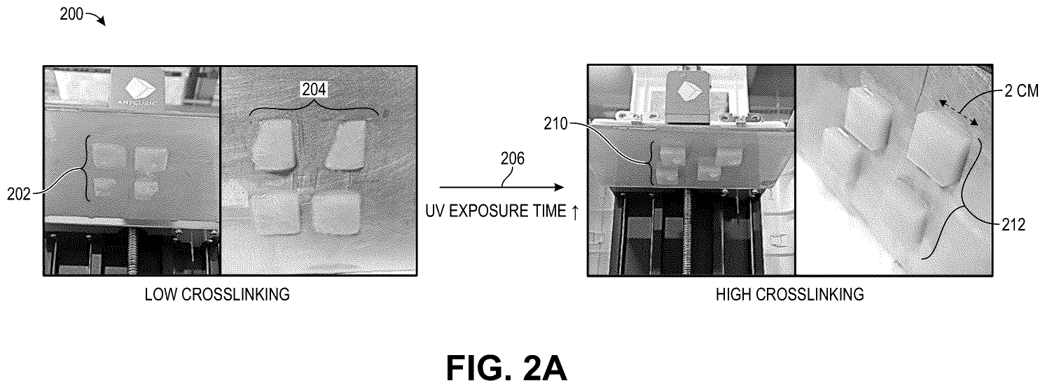

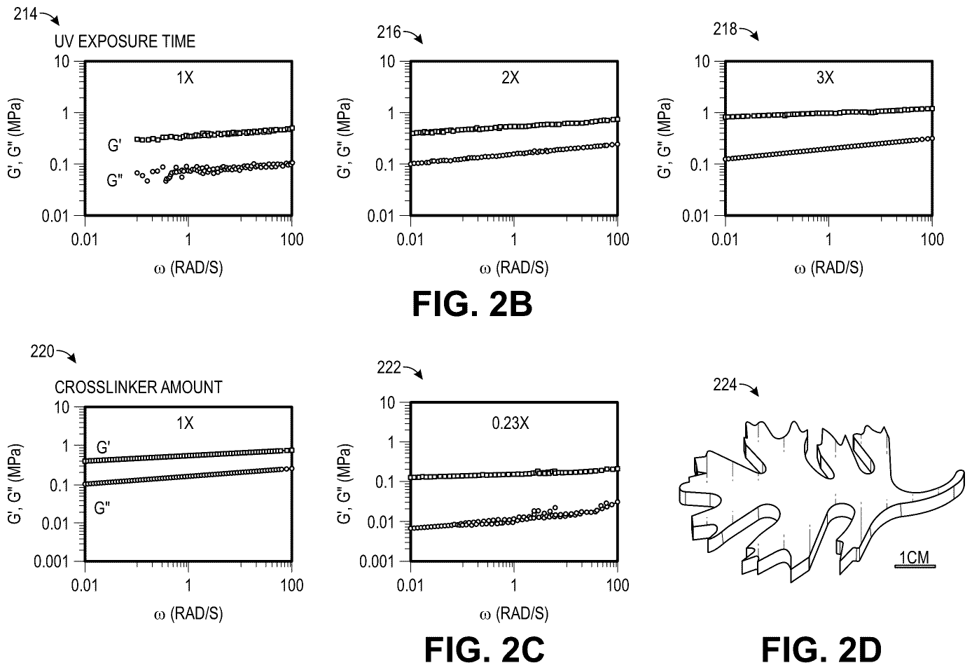

FIG. 2A depicts images of SMP-10/Genesis samples printed in cuboid structures via DLP (PhotonS) with different crosslinking degrees controlled by UV exposure time, in accordance with the present disclosure. FIG. 2B depicts plots exhibiting rheological frequency sweep profiles showing storage (G′) and loss moduli (G″) of the SMP-10/Genesis crosslinked with 1× (120 s), 2× (240 s), and 3× (360 s) UV exposure time (with a fixed 1× crosslinker amount; i.e., SMP-10:Genesis=1:1 by mass), in accordance with the present disclosure. (Admaflex with 10 s UV exposure time, 20% UV intensity). FIG. 2C shows plots depicting those crosslinked with 1× and 0.23× amounts of crosslinkers (with a fixed UV exposure time of 240 s), in accordance with the present disclosure. FIG. 2D depicts an exemplary part, an oak leaf 3D structure from SMP-10/Genesis (1×crosslinker formulation) printed with a different printer, in accordance with the present disclosure.

To relate the crosslinking to the mechanical response, a well-known acrylic crosslinking resin system was used to produce an SMP-10/Genesis hybrid formulation by controlling DLP parameters (e.g., UV exposure time using PhotonS) and crosslinker amount. Note that the SMP-10 alone is difficult to crosslink upon DLP without external crosslinkers. The degree of solidification can be represented by the solid-like behavior exhibited by higher G′ throughout the time range measured by rheometry and the crosslinking density can be directly associated with the stiffness from the rubber elasticity theory (eq 2),

$${G}^{′} ∝ \frac{ρ R T}{{M}_{x}} = υ RT \qquad ( eq 2 )$$

where p is the density of the polymer network, Mx is the molecular weight between the crosslinks, v is the crosslink density, R is the ideal gas constant and T is the absolute temperature. The printed samples 200 exhibit low crosslinking printed samples 202, 204. As expected, the longer exposure to light by way of additional ultraviolet (UV) exposure time 206, enabled the higher crosslinking density manifested by higher G′max, resulting in successful printing, as exhibited in printed samples after UV 208, with examples of high crosslinking printed samples 210, 212. The exposure time of 120 s (214), 240 s (216), and 360 s (218) resulted in G′max 0.48, 0.76, and 1.24 MPa, respectively (FIG. 2B). In contrast, the limited exposure to light led to poor crosslinking evident from the failed printing that lacked strong enough interlayer bonding and adhesion to the build plate (FIG. 2A). The reduced crosslinker concentration (0.23×, 222; as compared to 1×, 220) by design also evidently impacted the G′max showing an order of magnitude lower stiffness (FIG. 2C). To further prove the generality of controlled acrylic addition crosslinking on SMP-10, a small molecule of HDDA was used as the crosslinker for 3D printing. The rheological behaviors corresponded well to the trends observed from the SMP-10/Genesis system, where the reduced crosslinker amount (0.13×) resulted in an order of magnitude lower G′max, as noted in other studies. In addition, with a very low crosslinker concentration, it has been noted that the DLP printability was significantly impaired, consistent with the observation of low UV exposure time (FIG. 2A). Complementary FTIR analysis corroborated the successful chemical crosslinking as indicated by increasing C═O peaks from acrylates according to increasing crosslinker fractions in both SMP-10/Genesis and SMP-10/HDDA networks. The cross-hardware compatibility of the printable formulation was further validated by successfully printing an oak leaf structure with Admaflex instead of PhotonS, as was shown in the oak leaf structure 224 of FIG. 2D. These observations together support that the acrylic addition crosslinking via DLP results in distinguishable viscoelastic properties and printability.

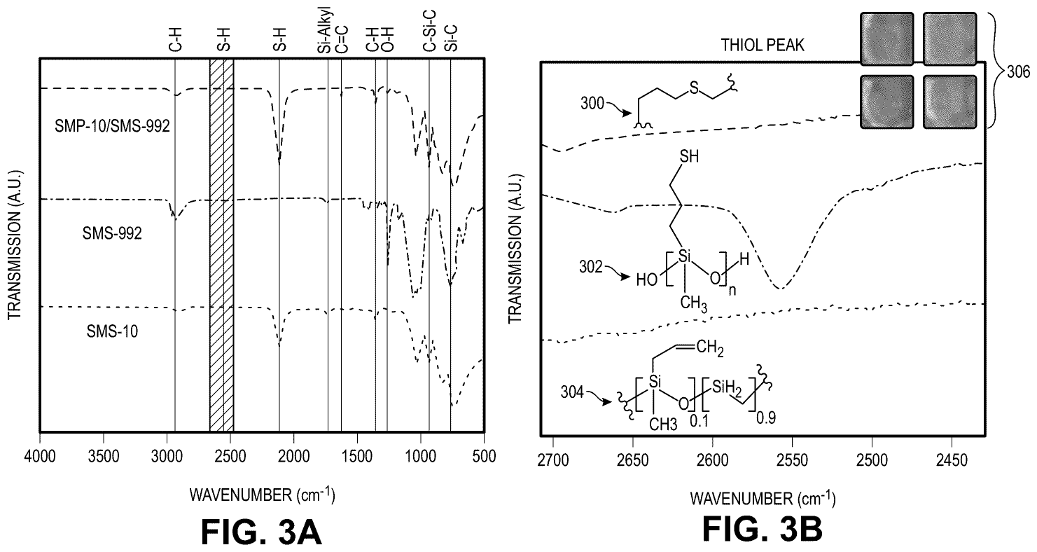

FIG. 3A depicts an FTIR spectra of SMP 1-10, SMS-992, and SMP-10/SMS-992 crosslinked network formed via thiol-ene click reaction, in accordance with the present disclosure. FIG. 3B depicts an FTIR spectra focused around 2550 cm⁻¹, highlighted region in FIG. 3A, while the inset image shows the cuboids of the SMP-10/SMS-992 hybrid 3D-printed in a window pattern, in accordance with the present disclosure. The inset chemical structures represent those of SMP-10 304, SMS-992 302, and SMP-10/SMS-992 hybrid 300, respectively, from bottom to top. An inset image 306 of cuboid samples of the materials shown in each of the plots of FIGS. 3A and 3B demonstrates the respective shapes of the sample materials.

Based on these observations, it was attempted to evaluate and generalize how manipulation of chemistry and VP parameters affects the viscoelasticity of the printed material, and whether those properties correlate with ceramic yield upon pyrolysis. To do so, thiol-ene click chemistry was employed to crosslink SMP-10 with SMS-992 (FIG. 1B). This approach produced a polycarbosilane-polycarbosiloxane hybrid network via DLP (using Admaflex, FIG. 3). It should be noted that SMP-10/SMS-992 Hybrids crosslinked in different UV intensities (80%, 85%, 90%), when printed in 3D cuboid structures, it can be observed that the cuboid structures printed from the lowest intensity exhibit the visible fluid-like “soft” feature where the structure shows apparent viscous flow-induced deformation by gravity. The successful chemical crosslinking was supported by FTIR analysis. For instance, the Si—H stretching observed around 2130 cm⁻¹ in SMP-10 also shows up in the SMP-10/SMS-992 system (FIG. 3A). The thiol groups at S—H stretching peak at 2563 cm⁻¹ in SMS-992, and its absence after the thiol-ene reaction supports the crosslinking between the SMP-10 and SMS-992 (FIG. 3B). Moreover, the O—H stretching around 1260 cm⁻¹ from SMS-992 appears in SMP-10/SMS-992, which also supports the successful incorporation of SMS-992 into SMP-10. All other signals align well with the expectations from the designated chemical synthesis paths shown in FIG. 1B. For example, a peak at 1758 cm⁻¹ (Si-Alkyl stretching) and C—Si—C stretching around 920 cm⁻¹ and C—H stretching vibrations around 2920 cm⁻¹ are observed in all SMP-10, SMS-992 and SMP-10/SMS-992 system as expected from their chemical structures (as shown in FIG. 1B, X3B).

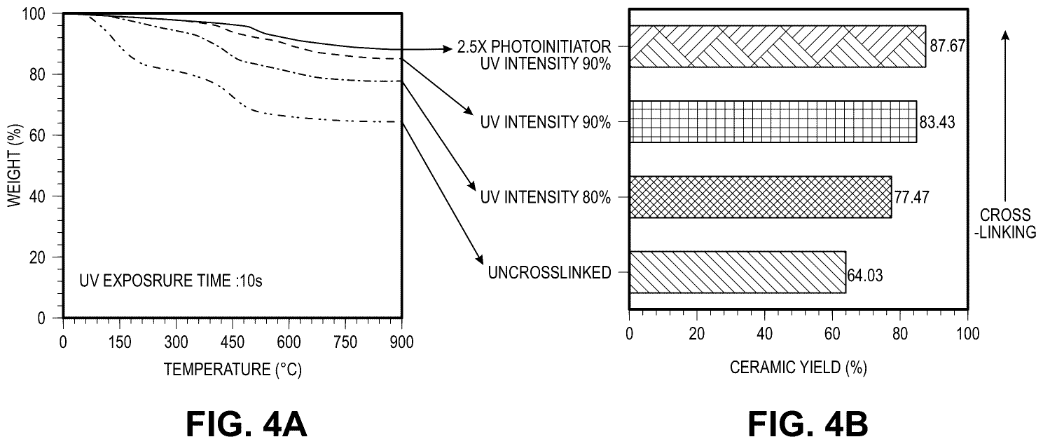

FIG. 4A is a plot showing compositions of ceramic yields after pyrolysis from the uncured SMP-10 (Uncrosslinked), SMP-10/SMS-992 hybrids crosslinked at UV intensity of 80%, 90% and that crosslinked with 2.5 times the photoinitiator amount at UV intensity of 90%, with TGA profiles of each sample with temperature ramped up to 900° C., in accordance with the present disclosure. FIG. 4B is a plot showing a comparison of ceramic yields (weight %) of each sample, with a UV exposure time of 10 seconds for all compared cases, in accordance with the present disclosure.

Based on this SMP-10/SMS-992 crosslinked system, the ceramic yield from the pyrolysis via thermal increment up to 900° C. in TGA can be assessed, as shown in FIG. 4. Here, the crosslinking degree was varied by altering DLP processing parameters and chemical reaction design. The TGA showed that the neat SMP-10 resin without DLP crosslinking (labeled Uncrosslinked) was converted to ceramic with ˜64% yield (FIG. 4A). The ceramic yield could be increased to ˜77% upon DLP crosslinking at a light intensity of 80%. Raising the light intensity to 90% increased the ceramic yield to ˜85%. When the photoinitiator concentration was increased by 2.5 times at this light intensity of 90%, the ceramic yield could be increased to ˜88%. These results indicate that an additional 24% ceramic yield can be obtain by manipulating the crosslinking alone without further engineering pyrolysis or post-treatment, as shown in FIG. 4B. The Uncrosslinked SMP-10 exhibited the lowest degradation onset temperature among all compared systems. Here, the initial weight loss up to −180° C. was previously attributed to incomplete hydrosilylation and dehydrocoupling, the second weight loss region around −430° C. to the evolution of both hydrogen and methane gases. The DLP crosslinking dramatically diminished or nearly eliminated the initial thermal weight loss stage, significantly enhancing ceramic yields. The second weight loss region from outgassing was also significantly decreased by crosslinking, especially for the more densely crosslinked samples.

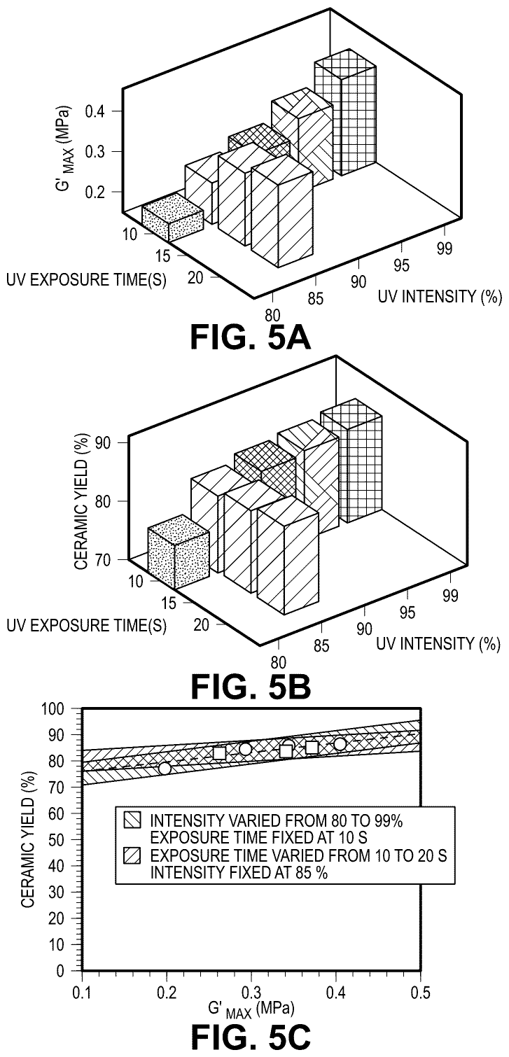

FIGS. 5A and 5B are plots exhibiting the effects of UV intensity and UV exposure time on SMP-10/SMS-992 hybrid system on (FIG. 5A) G′max and (FIG. 5B) ceramic yield, in accordance with the present disclosure. FIG. 5C is a plot showing correlation between crosslink density represented by G′max and ceramic yield, with circles indicating the data from varying UV intensity (80-99%) at a fixed UV exposure time of 10 s (linear fitting R2=0.81), and squares indicating the data from varying UV exposure times (10-20 s) at a fixed intensity of 85% (linear fitting R²=0.95). The trendline indicates the linear fitting from the combined datasets disregarding DLP conditions (R²=0.78), in accordance with the present disclosure.

To reveal the interconnection between the viscoelastic properties and ceramic yield, the trends in the G′max of SMP-10/SMS-992 systems with fine-tuned DLP processing parameters including UV intensity and exposure time were further investigated (as shown in FIG. 5A) and compared that with the ceramic yield (FIG. 5B). As noted from the acrylic crosslinking systems (such as in FIG. 2), the crosslink density altered by the reaction design and processing control could be connected directly with rheological G′max. The observations on SMP-10/SMS-992 agree well with such trends in crosslinking density and solid-like behavior (as shown in FIG. 5A), where increasing light intensity (from 80 to 99%) and longer UV exposure (from 10 to 20 seconds per layer) resulted in increasing G′max (from ˜0.2 MPa to ˜0.4 MPa), indicating the higher crosslinking density. The same trends were also observed in ceramic yield (FIG. 5B), where increasing the same DLP processing parameters above directly corresponded to the higher ceramic yield (from ˜77 to ˜86%). The observed G′max and ceramic yield could be linearly correlated with each other (FIG. 5C). While the linear correlation was found in the respective datasets where either of the selected DLP parameters (i.e., UV intensity and UV exposure time) was fixed, their combined datasets also closely fell within a linear relationship. Consistent with these observations, a direct comparison between the crosslinking density and the ceramic yield, achieved by varying the crosslinker concentration, showed that samples with higher crosslinker concentration resulted in higher ceramic yield as well as G′max. These findings together imply that it is viable to design, control, and predict the ceramic yield via tuning the crosslinking before or without the energy input for pyrolysis and irreversible thermal decomposition.

Using different VP crosslinking chemistries including acrylic addition polymerization and thiol-ene click reaction, it can be observed that the chemical composition design and VP processing control can be utilized to effectively tune the viscoelastic properties that are measurable via rheometry. It can be demonstrated that such pre-pyrolysis can be connected to and predictive of viscoelastic properties with the ceramic yield. Through these studies, a more sustainable, fast, non-destructive, energy and material-saving route to predict and enhance the ceramic yield can be realized. In addition, a one-pot hybridization of different preceramic polymers represented by polycarbosilane and polycarbosiloxane through DLP may additionally offer advantages in tailoring processing temperatures, ceramic yield, porosity, or microstructure of their PDCs from each constituent polymer. For example, polycarbosilanes are known to exhibit higher ceramic yield than polycarbosiloxanes as the latter contain oxygen atoms that can volatilize during pyrolysis. On the other hand, polycarbosiloxanes are useful for inducing porous microstructures owing to the existence of such volatile elements. In these plots, it is noteworthy that increasing crosslinking density using polycarbosiloxanes as the crosslinkers overcame the compromise in ceramic yield expected from the increased inclusion of volatile oxygen atoms from the siloxane group (as shown in FIGS. 4A-4B and FIGS. 5A-5C. This can be attributed to the crosslinking restricting the mobility of molecular fragments that are susceptible to break, including the segments containing the volatile elements, thus limiting the volatile byproduct release as can be observed from the TGA profiles (FIG. 4A). More macroscopically, the DLP crosslinking would produce a denser, robust network that better resists the heat-induced thermomechanical stress that leads to deformation, cracking, failure, and degradation. These findings therefore suggest that the ceramic yield can be enhanced by rational formulation, crosslinking path design, and VP process engineering even with constituent chemical species containing intrinsically volatile elements. Besides, these findings also imply that supplementary methods to control crosslink density such as post-curing or annealing on the green parts may be imparted to further tailor ceramic yields.

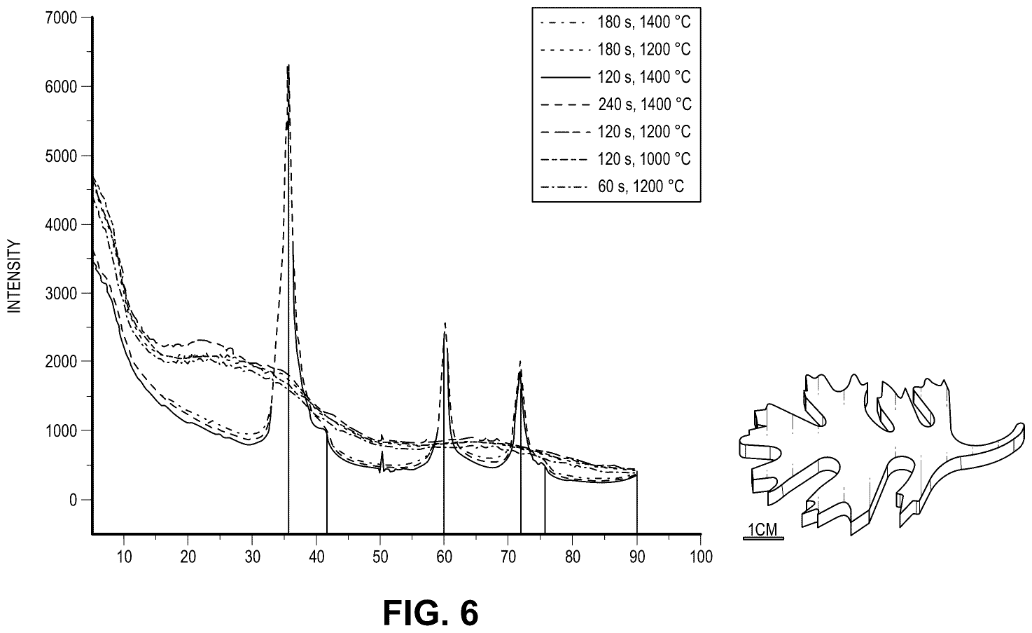

FIG. 6 is a plot of an X-ray Diffraction (XRD) measurement of an SMP-10/Genesis (1:1 weight ratio) crosslinked preceramic polymer, which can be pyrolyzed to produce amorphous SiC at 1000-1200° C. and crystallized to β-SiC at 1400° C. The crosslinking density of the preceramic polymer determined by the UV exposure time showed negligible effect on crystallinity after pyrolysis. The picture shows a pyrolyzed oak leaf structure similar to that produced from DLP (FIG. 2D). It should be noted that the exemplary preceramic networks described herein, for example, SMP-10/Genesis, can be converted to carbon-rich, amorphous or crystalline silicon carbide (SiC) ceramic, upon the choice of pyrolysis temperature (i.e., the former at 1000-1200° C. and the latter at 1400° C., respectively), as shown in the XRD measurement (FIG. 6). While no meaningful relation was determined between the post-pyrolysis crystallinity of PDCs and the pre-pyrolysis crosslink density of these preceramic polymers, future studies have the potential to elucidate how pyrolysis manipulation can alter the crystallization of the PDCs and possibly further improve the ceramic yield. One particular finding is that the crystallinity of this system was induced at 1400° C., which is 200° C. lower compared to that reported for neat SMP-10, which may be due to the residual crosslinker materials and crosslinking-induced denser distribution of nucleation sites facilitating the crystal growth. Additional details related to the size and morphology of the crystallites can be observed with techniques such as transmission electron microscopy and other similar techniques. In addition, further studies quantifying the crosslink density using a model system with a precisely known number of available crosslinking sites, well-defined Mx, and the backbone's MW and structure (eq 2), could serve such an end. These variables were difficult to specify in the present ingredient materials since their composition and MW were proprietary or presented in a broad range. Thus, G′max values were utilized instead to represent the crosslink density in the present disclosure (eq 2). The additional quantification of crosslink density can enable improved mechanistic studies on molecular-level dynamics in DLP crosslinking and pyrolysis to reveal the numerical relation between the crosslinking density and the ceramic yield. It should be noted that while examples and methods of the present disclosure were used DLP for the AM, the principles suggested here can be applied to different VP methods, such as SLA and 2PP, and other photopolymerization-based processing techniques.

### CONCLUSIONS

It has been shown that the VP can function as a versatile platform for diverse preceramic crosslinking reactions that govern the ceramic yield from pyrolysis. The rational design and DLP processing control on the photochemical crosslinking could enhance the ceramic yield to over 86% from 64%, even with crosslinkers containing volatile elements. The relationship determined between the stiffness of the polymer network and ceramic yield thus presents an intuitive, prompt, non-destructive, and energy-efficient approach to predict and improve ceramic yield before pyrolysis. Furthermore, the one-pot thiol-ene hybridization of polycarbosilane and polycarbosiloxane using DLP exemplifies a flexible strategy to combine different preceramic polymer components in desired 3D structure to potentially tailor processing temperatures, ceramic yield, porosity, and microstructure of PDCs. The correlation between the photo-crosslinking and ceramic yield using preceramic hybridization therefore offers fundamental insights to achieve broader classes of hybrid preceramic polymers and their PDCs with better-engineered properties, applications, and potentially higher ceramic yields. These insights will help advance cost-, resource-, energy-effectiveness, and manufacturing efficiency beyond traditional organic-inorganic processing, ultimately contributing to the global pursuit of a sustainable materials economy.

While the present teachings have been illustrated with respect to one or more implementations, alterations and/or modifications may be made to the illustrated examples without departing from the spirit and scope of the appended claims. For example, it may be appreciated that while the process is described as a series of acts or events, the present teachings are not limited by the ordering of such acts or events. Some acts may occur in different orders and/or concurrently with other acts or events apart from those described herein. Also, not all process stages may be required to implement a methodology in accordance with one or more aspects or embodiments of the present teachings. It may be appreciated that structural objects and/or processing stages may be added, or existing structural objects and/or processing stages may be removed or modified. Further, one or more of the acts depicted herein may be carried out in one or more separate acts and/or phases. Furthermore, to the extent that the terms “including,” “includes,” “having,” “has,” “with,” or variants thereof are used in either the detailed description and the claims, such terms are intended to be inclusive in a manner similar to the term “comprising.” The term “at least one of” is used to mean one or more of the listed items may be selected. Further, in the discussion and claims herein, the term “on” used with respect to two materials, one “on” the other, means at least some contact between the materials, while “over” means the materials are in proximity, but possibly with one or more additional intervening materials such that contact is possible but not required. Neither “on” nor “over” implies any directionality as used herein. The term “conformal” describes a coating material in which angles of the underlying material are preserved by the conformal material. The term “about” indicates that the value listed may be somewhat altered, as long as the alteration does not result in nonconformance of the process or structure to the illustrated embodiment. The terms “couple,” “coupled,” “connect,” “connection,” “connected,” “in connection with,” and “connecting” refer to “in direct connection with” or “in connection with via one or more intermediate elements or members.” Finally, the terms “exemplary” or “illustrative” indicate the description is used as an example, rather than implying that it is an ideal. Other embodiments of the present teachings may be apparent to those skilled in the art from consideration of the specification and practice of the disclosure herein. It is intended that the specification and examples be considered as exemplary only, with a true scope and spirit of the present teachings being indicated by the following claims.

What is claimed is:

1. A method for forming a three-dimensional part, comprising:
providing a container filled with a photopolymer resin;
directing a light source towards the container filled with the photopolymer resin to cure a first layer of the three-dimensional part;
forming one or more additional layers of the three-dimensional part by directing the light source towards the container filled with the photopolymer resin; and
removing the three-dimensional part from the container; and
heating the three-dimensional part.

2. The method for forming a three-dimensional part of claim 1, wherein the three-dimensional part has a ceramic yield of from about 60% to about 90%.

3. The method for forming a three-dimensional part of claim 1, wherein the photopolymer resin comprises a polycarbosilane.

4. The method for forming a three-dimensional part of claim 1, wherein the photopolymer resin comprises a methacrylate-based crosslinkable resin.

5. The method for forming a three-dimensional part of claim 1, wherein the photopolymer resin comprises a diacrylate.

6. The method for forming a three-dimensional part of claim 1, wherein the photopolymer resin comprises a homopolymer.

7. The method for forming a three-dimensional part of claim 1, wherein the photopolymer resin comprises a crosslinker comprising a thiol-containing molecule represented by the formula SiOₐC_{b}X_{c}S_{d}Hₑ; wherein:
X is selected from the group consisting of oxygen, boron, nitrogen, sulfur, hydrogen, titanium, platinum, and aluminum;
a is greater than or equal to 0;
b is greater than or equal to 0;
c s greater than or equal to 0;
d is greater than 0; and
e is greater than 0.

8. The method for forming a three-dimensional part of claim 1, wherein the photopolymer resin comprises a photoinitiator.

9. The method for forming a three-dimensional part of claim 1, wherein the light source operates in the ultraviolet range.

10. The method for forming a three-dimensional part of claim 1, wherein heating comprises exposing the three-dimensional part to a temperature of from about 500° C. to about 1400° C.

11. The method for forming a three-dimensional part of claim 1, wherein heating comprises exposing the three-dimensional part to an elevated temperature for a time of from about 0.5 hours to about 4 hours.

12. The method for forming a three-dimensional part of claim 1, wherein heating comprises maintaining an atmosphere around the three-dimensional part, wherein the atmosphere comprises argon.

13. A three-dimensional part, comprising:
a ceramic material comprising silicon and carbon;
a polycarbosilane; and
a polycarbosiloxane.

14. The three-dimensional part of claim 13, wherein the ceramic material has a ceramic yield of from about 60% to about 90%.

15. The three-dimensional part of claim 13, wherein the ceramic material has a stiffness of from about 0.2 MPa to about 0.5 MPa.

16. A composition, comprising:
a photopolymer resin, the photopolymer resin comprising:
a polycarbosilane;
a polycarbosiloxane; and
an acrylate-based crosslinkable resin.

17. The composition of claim 16, further comprising a diacrylate.

18. The composition of claim 16, further comprising a crosslinker.

19. The composition of claim 16, further comprising a photoinitiator.

20. The composition of claim 19, further comprising a thiol-containing molecule represented by the formula SiOₐC_{b}X_{c}S_{d}Hₑ; wherein:
X is selected from the group consisting of oxygen, boron, nitrogen, sulfur, hydrogen, titanium, platinum, and aluminum;
a is greater than or equal to 0;
b is greater than or equal to 0;
c s greater than or equal to 0;
d is greater than 0; and
e is greater than 0.
